(19) United States
(12) Patent Application Publication
(10) Pub. No.: US 2008/0266895 A1
(43) Pub. Date: Oct. 30, 2008

(54) OPTICAL PLATE AND BACKLIGHT MODULE USING THE SAME

(75) Inventor: SHAO-HAN CHANG, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/835,429

(22) Filed: Aug. 8, 2007

(30) Foreign Application Priority Data
Apr. 26, 2007 (CN) 200710200519.4

(51) Int. Cl. G02B 5/04; F21V 8/00

(52) U.S. Cl. 362/606; 359/837

(57) ABSTRACT

An exemplary optical plate includes at least one transparent plate unit. The transparent plate unit includes a first surface, a second surface, a plurality of microstructures, a plurality of elongated V-shaped protrusions and a lamp-receiving portion. The second surface is opposite to the first surface. The microstructures are formed at the first surface. Each microstructure includes at least three side surfaces connected with each other, a transverse width of each side surface decreasing along a direction away from the first surface. The elongated V-shaped protrusions are formed at the second surface. The lamp-receiving portion is defined in at least one of the first surface and the second surface. A backlight module using the present optical plate is also provided.

### CROSS-REFERENCE TO RELATED APPLICATIONS

This application is related to six copending U.S. patent applications, which are: applications serial no. [to be advised], Attorney Docket No. US13925, US13926, US13927, US13931, US14378, and US 14382, and entitled “OPTICAL PLATE AND BACKLIGHT MODULE USING THE SAME”. In all these copending applications, the inventor is Shao-Han Chang. All of the copending applications have the same assignee as the present application. The disclosures of the above identified applications are incorporated herein by reference.

### BACKGROUND OF THE INVENTION

1. Field of the Invention

The present invention relates to an optical plate for use in, for example, a backlight module, the backlight module typically being employed in a liquid crystal display (LCD).

2. Discussion of the Related Art

In a liquid crystal display device, liquid crystal is a substance that does not itself radiate light. Instead, the liquid crystal relies on light received from a light source, in order that the liquid crystal can facilitate the displaying of images and data. In the case of a typical liquid crystal display device, a backlight module powered by electricity supplies the needed light.

FIG. 9 represents a typical direct type backlight module 100. The backlight module 100 includes a housing 101, a light reflective plate 102, a light diffusion plate 103, a prism sheet 104, and a plurality of light emitting diode 105 (hereinafter called LED). The housing 101 includes a rectangular base 1011 and four sidewalls 101 3 extending from a periphery of the base 1011. The base 1011 and the four sidewalls 101 3 cooperatively define a chamber 107. Each LED 105 includes a base portion 1053 and a light-emitting portion 1051 disposed on the base portion 1053. The LEDs 105 are electrically connected to a printed circuit board (not labeled), and the printed circuit board is fixed to the base 1011 of the housing 101. The light reflective plate 102 is disposed on the LEDs 105 in the chamber 107. The light reflective plate 102 defines a plurality of through holes (not labeled) that allows the light-emitting portions 1051 of the LED 105 to pass through and emit light to be transmitted to the light diffusion plate 103. The light diffusion plate 103 and the prism sheet 104 are stacked in that order on the chamber 107. Light emitted from the LEDs 105 is substantially reflected by the light reflective sheet 102 to enter the light diffusion plate 103, and diffused uniformly in the light diffusion plate 103, and finally surface light is output from the prism sheet 104.

Generally, a plurality of dark areas may occur because of a reduced intensity of light between adjacent LEDs 105. In the backlight module 100, each LED 105 further includes a reflective sheet 106 disposed on the top of the light-emitting portion 1051, configured for decreasing the brightness of a portion of the backlight module 100 above the LED 105. However, the brightness of the backlight module 100 is still unduly non-uniform. In addition, to enhance the uniformity of brightness of the backlight module 100, there must be a certain space between the light diffusion plate 103 and the LEDs 105. This space can eliminate potential dark areas. Therefore the backlight module 100 may be unduly thick, and the overall intensity of the output light rays is reduced.

What is needed, therefore, is a new optical plate and a backlight module using the optical plate that can overcome the above-mentioned shortcomings.

### SUMMARY

An optical plate according to a preferred embodiment includes at least one transparent plate unit. The transparent plate unit includes a first surface, a second surface, a plurality of microstructures, a plurality of elongated V-shaped protrusions and a lamp-receiving portion. The second surface is opposite to the first surface. The microstructures are formed at the first surface. Each microstructure includes at least three side surfaces connected with each other, a transverse width of each side surface decreasing along a direction away from the first surface. The elongated V-shaped protrusions are formed at the second surface. The lamp-receiving portion is defined in at least one of the first surface and the second surface.

A backlight module according to a preferred embodiment includes a housing, a side-lighting type point light source, an optical plate, and a light diffusion plate. The housing includes a base and a plurality of sidewalls extending around a periphery of the base, the base and the sidewalls cooperatively forming an opening. The point light source is disposed on the base, each point light source having a light-emitting portion. The same optical plate as described in the previous paragraph is employed in this embodiment. The light-emitting portion of the point light source is inserted in the lamp-receiving portion of the optical plate correspondingly. The light diffusion plate is disposed on the housing over the opening.

Other advantages and novel features will become more apparent from the following detailed description of various embodiments, when taken in conjunction with the accompanying drawings.

### BRIEF DESCRIPTION OF THE DRAWINGS

The components in the drawings are not necessarily drawn to scale, the emphasis instead being placed upon clearly illustrating the principles of the present optical plate and backlight module. Moreover, in the drawings, like reference numerals designate corresponding parts throughout several views, and all the views are schematic.

FIG. 1 is a side cross-sectional view of a backlight module using an optical plate according to a first preferred embodiment of the present invention.

FIG. 2 is an isometric view of the optical plate of FIG. 1.

FIG. 3 is a cross-sectional view taken along line III-III of FIG. 2.

FIG. 4 is an isometric, inverted view of the optical plate of FIG. 2.

FIG. 5 is a side cross-sectional view of an optical plate according to a second preferred embodiment of the present invention.

FIG. 6 is a side cross-sectional view of an optical plate according to a third preferred embodiment of the present invention.

FIG. 7 is an exploded, isometric view of an optical plate according to a fourth preferred embodiment of the present invention.

FIG. 8 is an exploded, isometric view of an optical plate according to a fifth preferred embodiment of the present invention.

FIG. 9 is a side cross-sectional view of a conventional backlight module.

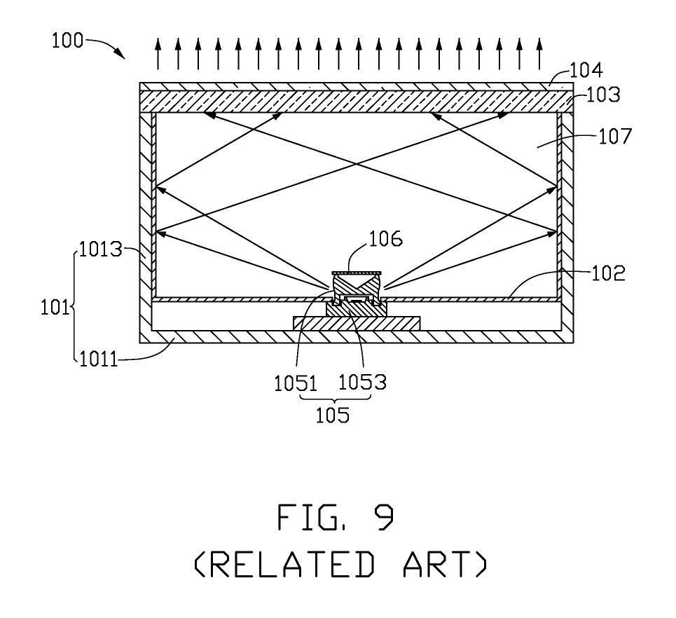

### DETAILED DESCRIPTION OF THE PREFERRED EMBODIMENTS

Reference will now be made to the drawings to describe preferred embodiments of the present optical plate and backlight module, in detail.

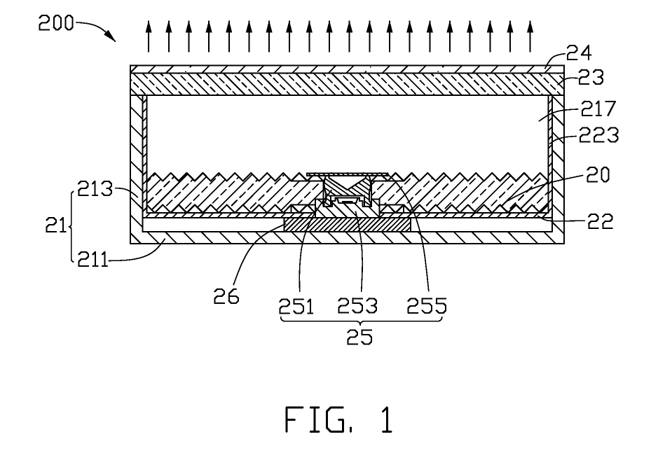

Referring to FIG. 1, a backlight module 200 in accordance with a first preferred embodiment is shown. The backlight module 200 includes a housing 21, a light reflective plate 22, a light diffusion plate 23, a side-lighting type LED 25, and an optical plate 20. The housing 21 includes a rectangular base 211 and four sidewalls 213 extending around a periphery of the base 211 correspondingly, the base 211 and the sidewalls 213 cooperatively form an opening 217. The light diffusion plate 23 is disposed on the housing 21 over the opening 217. The optical plate 20, the light reflective plate 22 and the LED 25 are received in the housing 21.

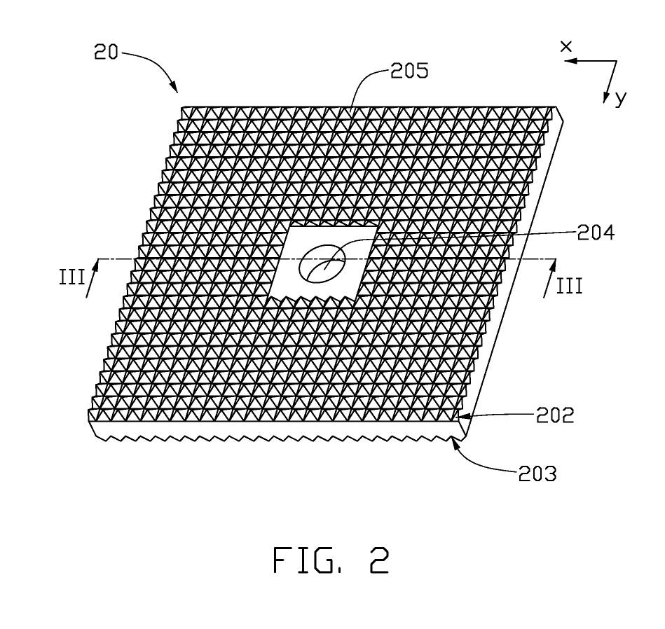

Referring to FIGS. 2 through 4, the optical plate 20 is a transparent square plate, and can be mounted into the housing 21. The optical plate 20 includes a light output surface 202, a bottom surface 203 opposite to the light output surface 202. A plurality of microstructures 205 are formed on the light output surface 202. A plurality of elongated V-shaped protrusions 206 are formed on the bottom surface 203. The optical plate 20 further includes a lamp-receiving portion 204 defined at a center of the bottom surface 203. In this embodiment, the lamp-receiving portion 204 is a through hole that communicates the light output surface 202 with the bottom surface 203. The optical plate 20 can be made from material selected from the group consisting of polycarbonate (PC), polymethyl methacrylate (PMMA), polystyrene (PS), copolymer of methylmethacrylate and styrene (MS), and any suitable combination thereof.

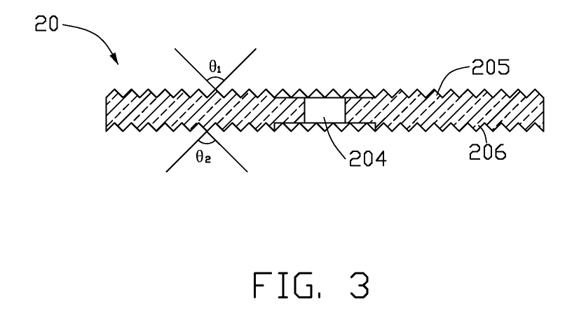

Referring to FIG. 2, the microstructures 205 are distributed on the light output surface 202 in a matrix manner. Each microstructure 205 includes four side surfaces (not labeled) connected with each other, a transverse width of each side surface decreasing along a direction away from the light output surface 202. A pitch of two adjacent microstructures 205 along an X-axis direction or a Y-axis direction is configured to be in a range from about 0.025 millimeters to about 2 millimeters. Also referring to FIG. 3, an dihedral angle θ₁ defined by two opposite side surfaces of each of the microstructures 205 is configured to be in a range from about 60 degrees to about 120 degrees.

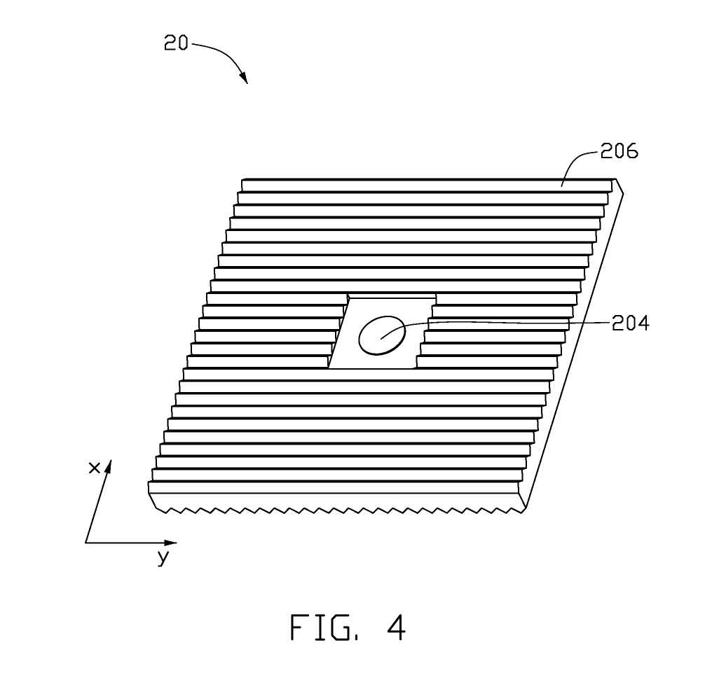

Referring to FIG. 4, in this embodiment, each elongated V-shaped protrusion 206 extends along a direction parallel to the Y-axis direction, and the elongated V-shaped protrusions 206 connect with each other. Likewise, a pitch of two adjacent elongated V-shaped protrusions 206 is configured to be in a range from about 0.025 millimeters to about 2 millimeters. Also referring to FIG. 3, a vertex angle θ₂ of each of the elongated V-shaped protrusions 206 is configured to be in a range from about 60 degrees to about 120 degrees.

Referring to FIGS. 1 and 2, in this embodiment, the side-lighting type LED 25 includes a base portion 253, a light-emitting portion 251 disposed on the base portion 253, and a reflective member 255 disposed on the top of the light-emitting portion 251. The LED 25 is electrically connected to a printed circuit board 26 that is fixed to the base 211 of the housing 21. The light-emitting portion 251 of the LED 25 is inserted into the lamp-receiving portion 204 of the optical plate 20, and the light output surface 202 of the optical plate 20 faces the light diffusion plate 23. The light reflective plate 22 defines a through hole (not labeled). The light reflective plate 22 is disposed underneath the bottom surface 203 of the optical plate 20, the LED 25 passing through the light reflective plate 22 via the through hole.

In use, light emitted from the light-emitting portion 251 of the LED 25 enters the optical plate 20 via an inner surface of the lamp-receiving portion 204. A significant amount of light transmits to the optical plate 20. A first amount of light is reflected at the elongated V-shaped protrusions 206 and/or the light reflective plate 22, and finally is outputted from the light output surface 202. If the optical plate 20 does not have the microstructures 205 at the light output surface 202, a second amount of light would undergo total reflection at the light output surface 202, thus light is still transmitted in the optical plate 20. On the other hand, due to the microstructures 205 having a plurality of slanted side surfaces, the second amount of the light can be outputted from the light output surface 202. Accordingly, a light energy utilization rate of the backlight module 200 is increased.

In addition, the microstructures 205 can condense and collimate emitted light, thereby improving a light illumination brightness. Furthermore, because the side-lighting type LED 25 is positioned in the lamp-receiving portion 204, light is uniformly outputted from the light output surface 202 of the optical plate 20 except that the portion above the LED 25 has a relatively low light output illumination. Light from the optical plate 20 can be further substantially mixed in a chamber between the optical plate 20 and the light diffusion plate 23, and finally uniform surface light is outputted from the light diffusion plate 23. A distance from the LED 25 to the light diffusion plate 23 may be configured to be very short, with little or no potential risk of having dark areas on the portion of the backlight module 200 directly above the LED 25. Accordingly, the backlight module 200 can have a thin configuration while still providing good, uniform optical performance.

It should be pointed out that, the light reflective plate 22 can be omitted. In an alternative embodiment, a high reflectivity film can be deposited on inner surfaces of the base 211 and the sidewalls 213 of the housing 21. In other alternative embodiment, the housing 21 is made of metal materials, and has high reflectivity inner surfaces.

It is to be understood that, in order to improve brightness of the backlight module 200 within a specific viewing range, the backlight module 200 can further include a prism sheet 24 disposed on the light diffusion plate 23. In addition, in order to improve light energy utilization rate of the backlight module 200, the light reflective plate 22 can further include four reflective sidewalls 223 extending around a periphery thereof and in contact with the corresponding sidewalls 213 of the housing 21. Furthermore, the microstructures 205 at the light output surface 202 may have other distributions, such as, an array of the matrix of the microstructures 205 can be slanted to a side surface of the optical plate 20 (along the Y-axis direction or the X-axis direction). Likewise, an extending direction of the elongated V-shaped protrusions can be slanted to the side surface of the optical plate (along the Y-axis direction or the X-axis direction).

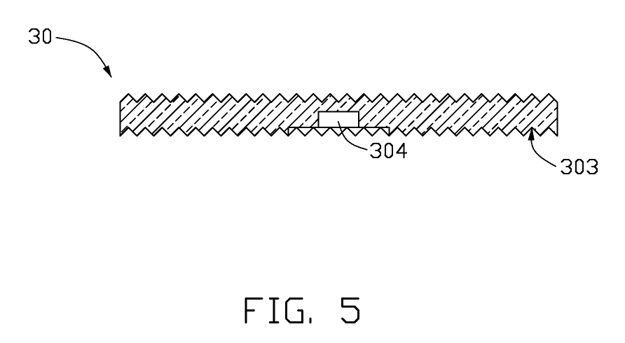

Referring to FIG. 5, an optical plate 30 in accordance with a second preferred embodiment is shown. The optical plate 30 is similar in principle to the optical plate 20 of the first embodiment, however the lamp-receiving portion 304 of the optical plate 30 is a blind hole. It should be pointed out that, a side-lighting type LED (not shown) without a reflective member can be mounted into the lamp-receiving portion 304 of the optical plate 30 to form a backlight module. Alternatively, a reflective member of the LED can be also positioned on a center of the optical plate 30 above the lamp-receiving portion 304.

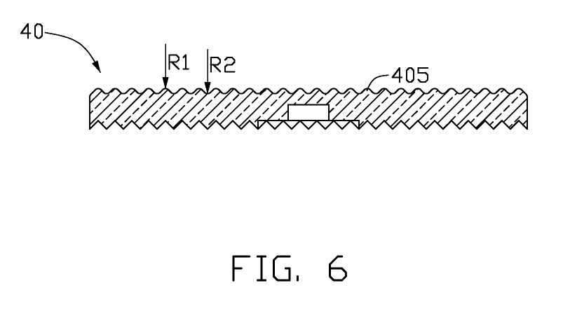

Referring to FIG. 6, an optical plate 40 in accordance with a third preferred embodiment is shown. The optical plate 40 is similar in principle to the optical plate 30, except that either dihedral angles defined by two opposite side surfaces of each microstructure 405 of the optical plate 40 or bottom angles defined by two adjacent microstructures 405 of the optical plate 40 are rounded to form first arcs angles R1 and second arcs angles R2 respectively. Either of the first round angle R1 and the second round angle R2 are equal to or less than 1.1 millimeters, and greater than zero. It is to be understood that, one or more of the dihedral angles defined by two opposite side surfaces of each microstructure, the bottom angles defined by two adjacent microstructures, vertex angles of the elongated V-shaped protrusions, and bottom angles defined by two adjacent elongated V-shaped protrusions, can also be rounded.

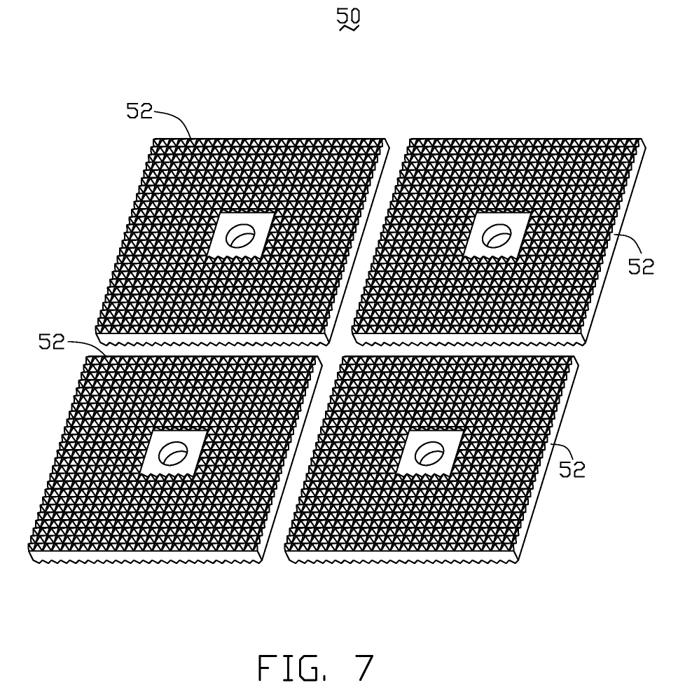

Referring to FIG. 7, a combined optical plate 50 in accordance with a fourth preferred embodiment is shown. The optical plate 50 includes four transparent plate units 52. Each transparent plate unit 52 is the same as the optical plate 20 of the first embodiment. The four transparent plate units 52 are tightly combined with each other to form the combined optical plate 50. It is to be understood that four side-lighting type LEDs and the combined optical plate 50 can be mounted into a housing to form a larger size backlight module.

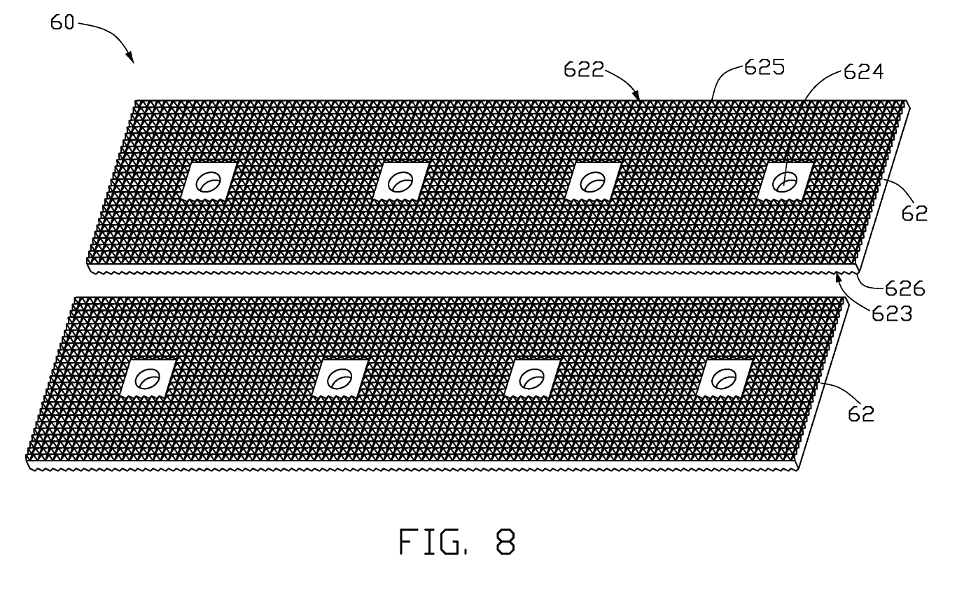

Referring to FIG. 8, another combined optical plate 60 in accordance with a fifth preferred embodiment is shown. The combined optical plate 60 includes two transparent plate units 62 that can be combined with together. Each transparent plate unit 62 is similar in principle to the optical plate 20, however, the transparent plate unit 62 is an elongated rectangular plate, and four lamp-receiving portions 624 are defined apart in each transparent plate unit 62. Either microstructures 625 formed at light output surface 622 or elongated V-shaped protrusions 626 formed at bottom surface 623, are similar as those of the optical plate 20. In use, a plurality of side-lighting type LEDs and the combined optical plate 60 can be mounted into a housing to form a larger size backlight module.

It is noted that the scope of the present optical plate is not limited to the above-described embodiments. In particular, even though specific shape of microstructures (pyramidal protrusions) 205, 405, 625 have been described and illustrated, the microstructures (pyramidal protrusions) 205, 405, 625 can have various other suitable shapes. For example, the microstructures can be three-sided (triangular) pyramidal protrusions, five-sided (pentagonal) pyramidal protrusions, multi-sided (polygonal) pyramidal protrusions, or frustums of these.

It should be noted that, in the backlight module 200, not only the optical plate 20 can be positioned in the housing 21 and the light output surface 202 faces the light diffusion plate 23, but also the optical plate 20 can be positioned in the housing 21 and the bottom surface 203 faces the light diffusion plate 23. That is, the microstructures 205 are formed at a first surface of the optical plate 20, and the V-shaped protrusions 206 are formed at a second surface of the optical plate 20. The first surface is selected from one of the light output surface 202 and the bottom surface 203, and the second surface is selected from the other one of the light output surface 202 and the bottom surface 203.

In a backlight module using the combined optical plates of the fourth and fifth embodiments, a plurality of red, green, and blue colored LEDs can be inserted into the lamp-receiving portions of the combined optical plates, such that a mixed white surface light can be obtained. It is to be understood that other kinds of point light source, such as field emission lamps and so on, can replace the LEDs 25 in above embodiments.

Finally, while various embodiments have been described and illustrated, the invention is not to be construed as being limited thereto. Various modifications can be made to the embodiments by those skilled in the art without departing from the true spirit and scope of the invention as defined by the appended claims.

What is claimed is:

1. An optical plate comprising:
at least one transparent plate unit having:
a first surface;
a second surface opposite to the first surface;
a plurality of microstructures formed at the first surface, wherein each microstructure comprises at least three side surfaces connected with each other, a transverse width of each side surface decreasing along a direction away from the first surface;
a plurality of elongated V-shaped protrusions formed at the second surface; and at least a lamp-receiving portion defined in at least one of the first surface and the second surface.

2. The optical plate according to claim 1, wherein the microstructures are selected from a group consisting of triangular pyramidal protrusions, rectangular pyramidal protrusions, pentagonal pyramidal protrusions, polygonal pyramidal protrusions, and frustums of these.

3. The optical plate according to claim 2, wherein the microstructures are rectangular pyramidal protrusions, a dihedral angle defined by two opposite side surfaces of each of the microstructures is configured to be in a range from about 60 degrees to about 120 degrees.

4. The optical plate according to claim 2, wherein the microstructures are rectangular pyramidal protrusions, a pitch of the two adjacent microstructures is configured to be in a range from about 0.025 millimeters to about 2 millimeters.

5. The optical plate according to claim 1, wherein the microstructures are distributed on the first surface in a matrix manner, and one array of the matrix of the microstructures are distributed along a direction parallel to or slanted to a side surface of the optical plate.

6. The optical plate according to claim 1, wherein each of the elongated V-shaped protrusions extends along a direction parallel to a side surface of the optical plate, and the elongated V-shaped protrusions connect with each other.

7. The optical plate according to claim 6, wherein a pitch of the two adjacent elongated V-shaped protrusions is configured to be in a range from about 0.025 millimeters to about 2 millimeters, and a vertex angle of each of the elongated V-shaped protrusions is configured to be in a range from about 60 degrees to about 120 degrees.

8. The optical plate according to claim 1, wherein the lamp-receiving portion is selected from one of blind hole and through hole communicating between the first surface and the second surface.

9. The optical plate according to claim 1, wherein one or more of dihedral angles defined by two opposite side surfaces of each microstructure, bottom angles defined by two adjacent microstructures, vertex angles of the elongated V-shaped protrusions, and bottom angles defined by two adjacent elongated V-shaped protrusions, are rounded.

10. The optical plate according to claim 1, wherein the optical plate includes a plurality of the transparent plate units, the transparent plate units being tightly combined with each other.

11. A backlight module comprising:
a housing having a base and a plurality of sidewalls extending from a periphery of the base, the base and the sidewalls cooperatively forming an opening;
at least one side-lighting type point light source disposed on the base, each point light source having a light-emitting portion;
an optical plate positioned in the housing, the optical plate including at least one transparent plate unit having:
a first surface;
a second surface opposite to the first surface;
a plurality of microstructures formed at the first surface, wherein each microstructure comprises at least three side surfaces connected with each other, a transverse width of each side surface decreasing along a direction away from the first surface;
a plurality of elongated V-shaped protrusions formed at the second surface; and a lamp-receiving portion defined in at least one of the first surface and the second surface, wherein the light-emitting portion of the at least one point light source is inserted in the lamp received portion; and
a light diffusion plate disposed on the housing over the opening.

12. The backlight module according to claim 11, further comprising a light reflective plate defining a through hole therein, the light reflective plate being disposed underneath the bottom surface of the optical plate, and the point light source passing through the light reflective plate via the through hole.

13. The backlight module according to claim 12, wherein the light reflective plate further comprises a plurality of reflective sidewalls extending from a periphery thereof and contact with the sidewalls of the housing.

14. The backlight module according to claim 11, wherein the housing is made of metal materials, and has high reflectivity inner surfaces.

15. The backlight module according to claim 11, further comprising a high reflectivity film deposited on inner surfaces of the base and the sidewalls of the housing.

16. The backlight module according to claim 11, further comprising a prism sheet disposed on the light diffusion plate.

17. The backlight module according to claim 11, wherein the microstructures are selected from a group consisting of triangular pyramidal protrusions, rectangular pyramidal protrusions, pentagonal pyramidal protrusions, polygonal pyramidal protrusions, and frustums of these.

18. The backlight module according to claim 11, wherein the lamp-receiving portion is selected from one of blind hole and through hole communicating between the first surface and the second surface.

19. The backlight module according to claim 11, wherein one or more of dihedral angles defined by two opposite side surfaces of each microstructure, bottom angles defined by two adjacent microstructures, vertex angles of the elongated V-shaped protrusions, and bottom angles defined by two adjacent elongated V-shaped protrusions, are rounded.
